(19) United States
(12) Patent Application Publication
(10) Pub. No.: US 2009/0323832 A1
(43) Pub. Date: Dec. 31, 2009

(54) Wireless Communication System, Wireless Communication Terminal, Base Station, Wireless Communication Method and Computer Program of Wireless Communication Method

(75) Inventor: Mitsuharu Senda, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/065,078

(22) PCT Filed: Aug. 29, 2006
(86) PCT No.: PCT/JP2006/316950

§ 371 Date: Jul. 27, 2009

(30) Foreign Application Priority Data
Aug. 30, 2005 (JP) 2005-248953

(51) Int. Cl. H04B 1/00; H04B 7/00; H04L 27/00

(52) U.S. Cl. 375/259; 455/69; 455/63.1

(57) ABSTRACT

A wireless communication system to which an adaptive modulation method is applied, in order to prevent characteristics of error ratio from being deteriorated more efficiently than prior techniques and to improve the throughput, one or each of a base station and a wireless communication terminal including: a communication line quality detection unit which detects a first parameter with regard to quality of communication line and detects fluctuation of the first parameter; a receiving method detection unit which detects the receiving method; and a modulation method determination unit which determines the modulation method based on both the fluctuation of the first parameter and the receiving method.

### TECHNICAL FIELD

The present invention relates to a wireless communication system, a wireless communication terminal, a base station, a wireless communication method and a computer program of the wireless communication method.

Priority is claimed on Japanese Patent Application No. 2005-248953, filed Aug. 30, 2005, the content of which is incorporated herein by reference.

### BACKGROUND ART

In the recent years, one of the solutions resolving wireless communication systems need for a high speed data communication is applying adaptive modulation which provides and switches multiple modulation methods in accordance with the conditions and/or quality of communication lines. Multiple modulation methods are used which each has different bit rates, such as, in ascending order of the bit rate, BPSK (Binary Phase Shift keying), QPSK (Quadrature Phase Shift keying), 16QAM (16 Quadrature Amplitude Modulation) and 64QAM (64 Quadrature Amplitude Modulation).

FIG. 7 is a block diagram which shows a conventional wireless communication system including a conventional adaptive modulation. It should be noted that in the following explanations, the adaptive modulation is applied when communicating in a direction from a base station 1 to a wireless communication terminal 2 (such as a mobile communication terminal). However, it is possible to apply the same explanations even in the case of a direction from the wireless communication terminal 2 to the base station 1.

In the base station 1, a modulation method determination portion 11 initially chooses one of the above-described commonly used modulation methods and sets the chosen method to a transmission baseband operation portion 12. The transmission baseband operation portion 12 modulates the transmission data according to the modulation method set above. A transmission RF operation portion 13 converts the modulated signals to RF signals and transmits the converted signals to the wireless communication terminal 2.

In the wireless communication terminal 2, a receiving RF operation portion 21 receives the above-described RF signals and converts the received RF signals to the baseband signals. After that, a received baseband signal operation portion 22 demodulates the baseband signals to the originally transmitted data before modulation. Next, a communication line quality detection portion 23 calculates the average value of SNR (signal-to-noise ratio) which indicates the quality of the communication line, and outputs the average value to a transmission baseband operation portion 24. The transmission baseband operation portion 24 multiplexes the above-described average SNR as communication line quality information into transmission data which is transmitted to the wireless communication terminal 2. A transmission RF operation portion 25 converts the above-described multiplexed transmission data to RF signals and transmits the RF signals to the base station 1.

In the base station 1, a receiving RE operation portion 14 converts the RF signals including the communication line quality information received from the wireless communication terminal 2 to the baseband signals. After that, a receiving baseband operation portion 15 demodulates the baseband signals and extracts the above-described communication line quality information in order to notify the communication line quality information to the modulation method determination portion 11. The modulation method determination portion 11 determines which modulation method will be used for the subsequent transmission of data based on the communication line quality information. The process of determining the modulation method to be used by the modulation method determination portion 11 is more concretely explained in reference to FIG. 8. FIG. 8 is a drawing of characteristics and shows a relationship between the SNR and the FER (Frame Error Rate) of each of the modulation methods. In order to limit the FER to a threshold α or less, the modulation method determination portion 11 selects the modulation method which indicates an FER of a or less. For example, if the communication line quality is ×1, in other words, if the average the SNR is ×1, the modulation method determination portion 11 compares the average SNR of ×1 to α (10⁻²) which is set as a threshold of the FER and a determination is made to apply QPSK as the modulation method based on the drawing of characteristics shown in FIG. 8. It should be noted that the above-described threshold α is the minimum level of a frame error rate which is necessary in this case of the wireless communication system. For example, if the average SNR is ×2, 64QAM is selected as the modulation method. The modulation method determination portion 11 sets the modulation method which has been selected in such a manner to the transmission baseband operation portion 12, and the transmission baseband operation portion 12 modulates the transmission data in accordance with the determined modulation method.

In accordance with such a series of communication operations, the modulation method is switched to another method which has a higher bit rates in order to accelerate the data transmission speed if the quality of communication line is good, and the modulation method is switched to another method which has a lower bit rates in order to optimize the data transmission speed which is appropriate or harmonized to the overall communication conditions if the quality of communication line is poor. It is possible to determine which modulation method can maintain the minimum level of the frame error ratio because the threshold α is set to the FER as a threshold for determining the modulation method.

On the other hand, for example, if the wireless communication terminal 2 is moving, the SNR fluctuates widely in accordance with acceleration. Therefore, if the modulation method is determined by using the average SNR as described above, and the SNR is low, it is not possible to determine the most appropriate modulation method. That is, there is a problem in which a lower throughput is caused because it is not possible to obtain accurate characteristics of the error ratio. In order to resolve such a problem, for example, Japanese Patent Application, First Publication No. 2004-363712 discloses a technique in which the threshold used for determining the modulation method is changed in consideration of fluctuation and quality changes of the communication line, and therefore, the technique tries to prevent the error rate characteristics from being deteriorated and to improve the throughput.

[Patent Document I] Japanese Patent Application, First Publication No. 2004-363712

### DISCLOSURE OF INVENTION

In accordance with the technique in the above-described Patent Document 1, only the fluctuation of and quality changes of the communication line which depend on a moving speed of the wireless communication terminal are considered, but there are cases in which the quality of the communication line fluctuates and changes due to other reasons. For example, there is a case in which the degree of fluctuation and changes in quality of the communication line can differ in accordance with the receiving method used (single antenna receiving method, diversity antenna receiving method, adaptive array antenna receiving method, and the like). Therefore, the technique disclosed in Patent Document 1 cannot be completely applicable to fluctuation and changes of quality of the communication line.

The present invention was conceived in order to resolve the above-described problems, and the present invention has objectives to improve the throughput of the wireless communication system using the adaptive modulation method by preventing lowering error ratio characteristics more efficiently than prior techniques.

In order to achieve the above-described objectives, the present invention provides a first solution of a wireless communication system which switches modulation methods applied to communication between a base station and a wireless communication terminal upon conducting the communication, wherein one or each of the base station and the wireless communication terminal includes: a communication line quality detection unit which detects a first parameter with regard to quality of communication line and detects fluctuation thereof, a receiving method detection unit which detects a receiving method; and a modulation method determination unit which determines the modulation method based on the fluctuation of both the first parameter and the receiving method.

Moreover, the present invention provides a second solution of a wireless communication method which is the above-described first solution, wherein in order to determine the modulation method based on pre-calculated characteristics of each of the modulation methods that indicate a relationship between the first parameter and a second parameter of error ratio, the modulation method detection unit compares an average value of the first parameter to a predetermined threshold value which is set to the second parameter and which is adjusted based on both fluctuation of the first parameter and the receiving method.

Moreover, the present invention provides a third solution of a wireless communication method which is the above-described first or second solution, wherein the threshold value is corrected based on both fluctuation of the first parameter which depends on a moving speed of the wireless communication terminal and fluctuation of the first parameter which depends on the receiving method.

Moreover, the present invention provides a fourth solution of a wireless communication method which is one of the above-described first to third solutions, wherein the first parameter is a signal-to-noise ratio.

In addition, the present invention provides a fifth solution of a wireless communication method which is one of the above-described first to fourth solutions, wherein the second parameter is a frame error ratio.

Moreover, the present invention provides a first solution of a wireless communication terminal which communicates with a base station, including: a communication line quality detection unit which detects a first parameter with regard to quality of communication line and detects fluctuation of the first parameter; a receiving method detection unit which detects a receiving method; and a modulation method determination unit which determines the modulation method based on the fluctuation of the first parameter and the receiving method.

Moreover, the present invention provides a first solution of a base station which communicates with a wireless communication terminal, including: a communication line quality detection unit which detects a first parameter with regard to quality of communication line and detects fluctuation of the first parameter; a receiving method detection unit which detects a receiving method; and a modulation method determination unit which determines the modulation method based on the fluctuation of the first parameter and the receiving method.

On the other hand, the present invention provides a first solution of a wireless communication method which switches modulation methods applied to communication between a base station and a wireless communication terminal when conducting the communication, including: a first step of detecting a first parameter with regard to quality of communication line and detecting fluctuation of the first parameter; a second step of detecting a receiving method; and a third step of determining the modulation method based on the fluctuation of the first parameter and the receiving method.

In addition, the present invention provides a first solution of a computer program which switches modulation methods applied to communication between a base station and a wireless communication terminal when conducting the communication, and which is stored in one or each of the base station and the wireless communication terminal, including: a step of detecting a first parameter with regard to quality of communication line and fluctuation of the first parameter and detecting a receiving method; and a step of determining the modulation method based on the fluctuation of the first parameter and the receiving method.

In accordance with the present invention, the threshold used upon determining the modulation method is adjusted or corrected in consideration of fluctuation and changes of quality of the communication line, and therefore, it is possible to select the most appropriate modulation method, it is possible to prevent lowering the error rate characteristics, and it is possible to improve the throughput.

### BRIEF DESCRIPTION OF THE DRAWINGS

FIG. 1 is a block diagram showing a constitution of a mobile communication system of one embodiment of the present invention.

FIG. 2 is a flowchart showing a process for determining the modulation method by a modulation method determination portion 11 of one embodiment of the present invention.

FIG. 3A is a drawing for explaining fluctuation and changes in the SNR caused in accordance with a moving speed of a wireless communication terminal 2 of one embodiment of the present invention.

FIG. 3B is a drawing for explaining fluctuation and changes in the SNR caused in accordance with a moving speed of a wireless communication terminal 2 of one embodiment of the present invention.

FIG. 4A is a drawing for explaining fluctuation and changes in the SNR caused by applying different receiving methods in one embodiment of the present invention.

FIG. 4B is a drawing for explaining fluctuation and changes in the SNR caused by applying different receiving methods in one embodiment of the present invention.

FIG. 4C is a drawing for explaining fluctuation and changes in the SNR caused by applying different receiving methods in one embodiment of the present invention.

FIG. 5 is a drawing which shows an example of a correction value table of one embodiment of the present invention.

FIG. 6 is a drawing for explaining a fundamental theory of an operation of determining a modulation method by a modulation method determination portion 11 in one embodiment of the present invention.

FIG. 7 is a block diagram showing a constitution of a conventional mobile communication system.

FIG. 8 is a drawing for explaining a fundamental theory of an operation of determining a modulation method in a conventional technique.

### DESCRIPTION OF THE REFERENCE SYMBOLS

1: base station, 11: modulation method determination portion, 12: transmission baseband operation portion, 13: transmission RF operation portion, 14: receiving RF operation portion, 15: receiving baseband operation portion, 2: wireless communication terminal, 21: receiving RF operation portion, 22: receiving baseband operation portion, 23: circuit quality detection portion, 24: transmission baseband operation portion, 25: transmission RF operation portion, 26: receiving method detection portion

### BEST MODE FOR CARRYING OUT THE INVENTION

Hereinafter, one embodiment of the present invention is explained with reference to the drawings.

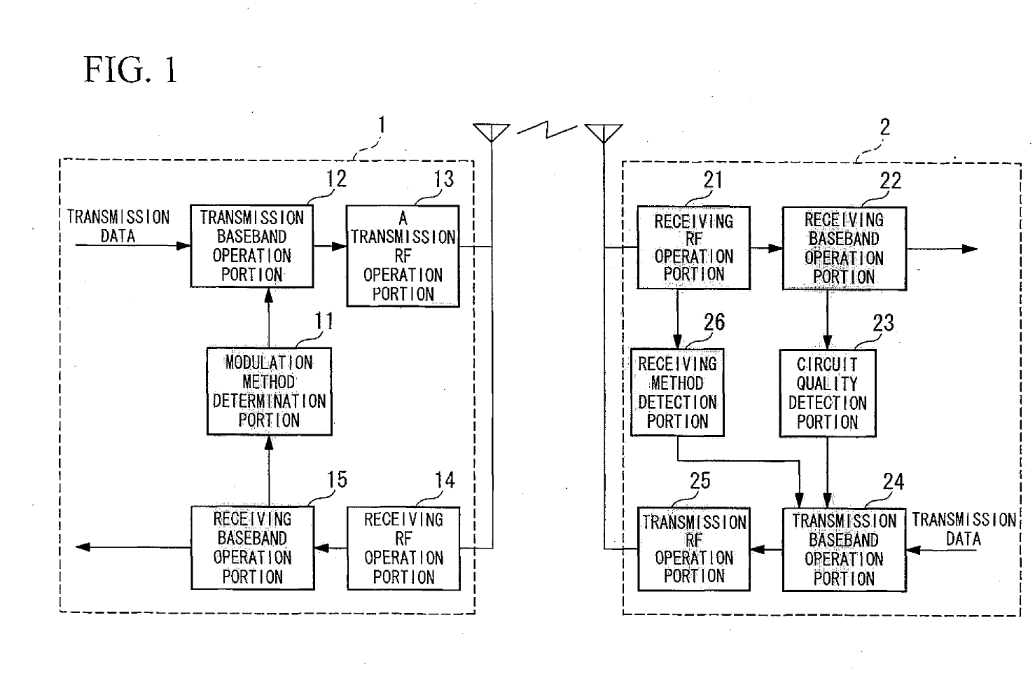

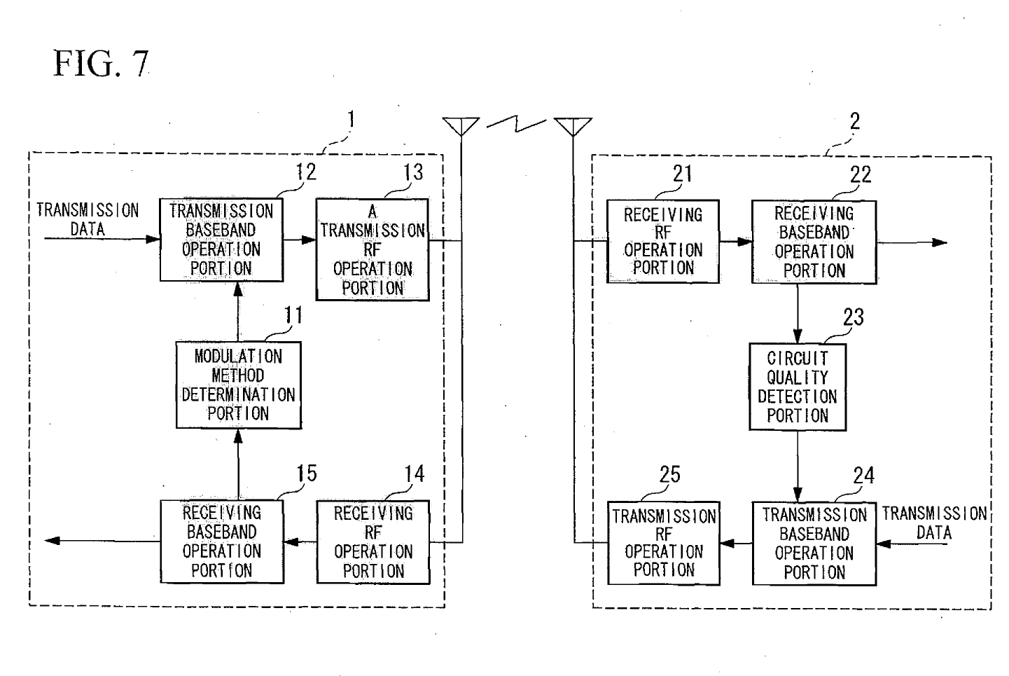

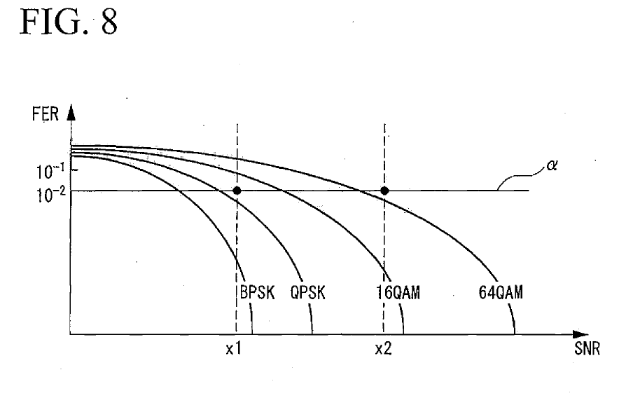

FIG. 1 is a block diagram showing a wireless communication system to which an adaptive modulation method of the present invention is applied and which is constituted from both a base station 1 and a wireless communication terminal 2 (for example, a mobile communication terminal), and the reference numerals are assigned to the constitutional elements in FIG. 1 correspond to the constitutional elements in FIG. 7. As shown in FIG. 1, the base station 1 is constituted from a modulation method determination portion 11, a transmission baseband operation portion 12, a transmission RF operation portion 13, a receiving RF operation portion 14 and a receiving baseband operation portion 15. On the other hand, the wireless communication terminal 2 is constituted from a receiving RF operation portion 21, a receiving baseband operation portion 22, a circuit quality detection portion 23, a transmission baseband operation portion 24, a transmission RF operation portion 25 and a receiving method detection portion 26. It should be noted that the following explanation is the case of the adaptive modulation method applied to a communication in a direction from the base station 1 to the wireless communication terminal 2, but it is possible to apply the same method to the case of a communication in a direction from the wireless communication terminal 2 to the base station 1.

In the base station 1, in an initial state, the modulation method determination portion 11 initially sets one of modulation methods (BPSK, QPSK, 16QAM and 64QAM) to the transmission baseband operation portion 12 that is normally or most typically used method. It should be noted that the modulation method determination portion 11 determines the modulation method based on both the communication line quality information and the receiving method information input from the receiving baseband operation portion 15, and sets the determined modulation method to the transmission baseband operation portion 12. A determining operation of the modulation method by the modulation method determination portion 11 is explained in detail below.

The transmission baseband operation portion 12 modulates the transmission data according to the modulation method set by the modulation method determination portion 11, and outputs transmission data to the transmission RF operation portion 13. The transmission RF operation portion 13 converts the transmission data modulated by the transmission baseband operation portion 12 to RF signals, and transmits the converted RF signals to the receiving RF operation portion 21 of the wireless communication terminal 2.

In the wireless communication terminal 2, the receiving RF operation portion 21 receives the above-described RE signals in accordance with either the single antenna receiving method, the diversity antenna receiving method or the adaptive array antenna receiving method; obtains baseband signals by a frequency conversion operation; and outputs the baseband signals to the receiving baseband operation portion 22. The receiving baseband operation portion 22 demodulates the above-described baseband signals in order to obtain the data before transmission, and outputs the data to the communication line quality detection portion 23. The communication line quality detection portion 23 calculates an average SNR which indicates the quality of the communication line and which is obtained based on the above-described demodulated data, and moreover calculates the SNR fluctuation data which indicates the fluctuation of the SNR. The communication line quality detection portion 23 outputs both the average SNR and the SNR fluctuation data that are the communication line quality information to the transmission baseband operation portion 24. The receiving method detection portion 26 obtains the receiving method information which indicates the receiving method of the receiving RF operation portion 21, and outputs the receiving method information to the transmission baseband operation portion 24. The transmission baseband operation portion 24 conducts multiplexing and modulation in order to include both the communication line quality information and the receiving method information into the transmission data of the wireless communication terminal 2, and outputs the transmission data to the transmission RF operation portion 25. The transmission RF operation portion 25 converts the multiplexed and modulated transmission data to the RF signals and transmits the RE signals to the base station 1.

In the base station 1, the receiving Rf operation portion 14 conducts a frequency conversion operation in order to convert the RF signals including both the communication line quality information and the receiving method information received from the wireless communication terminal 2 to the baseband signals, and outputs the baseband signals to the receiving baseband operation portion 15. The receiving baseband operation portion 15 demodulates the baseband signals inputted from the receiving RF operation portion 14, extracts the above-described communication line quality information and the receiving method information, and outputs the communication line quality information and the receiving method information to the modulation method determination portion 11.

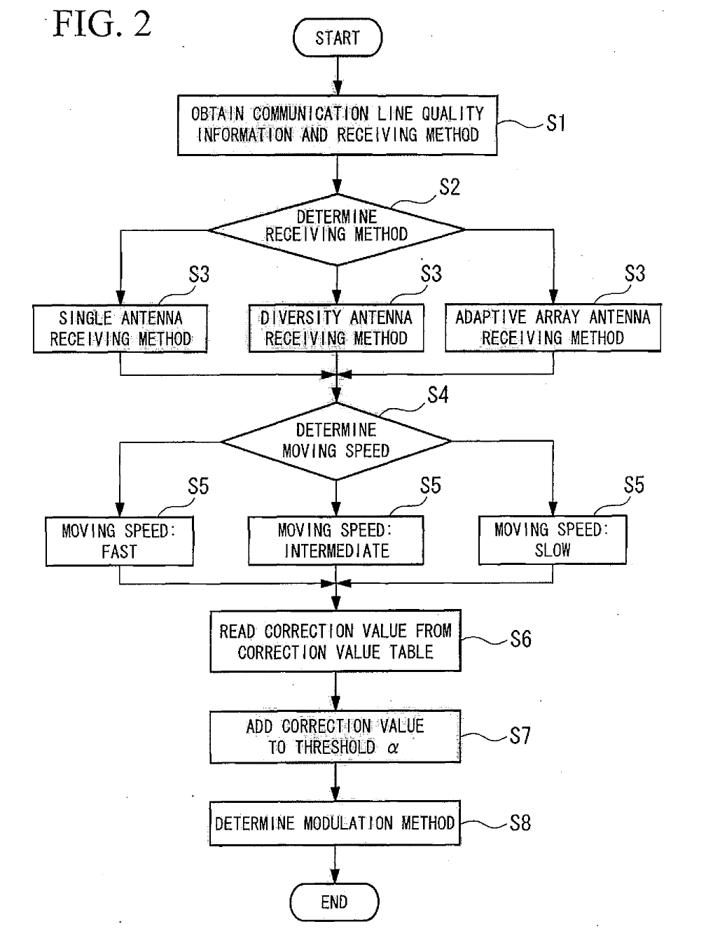

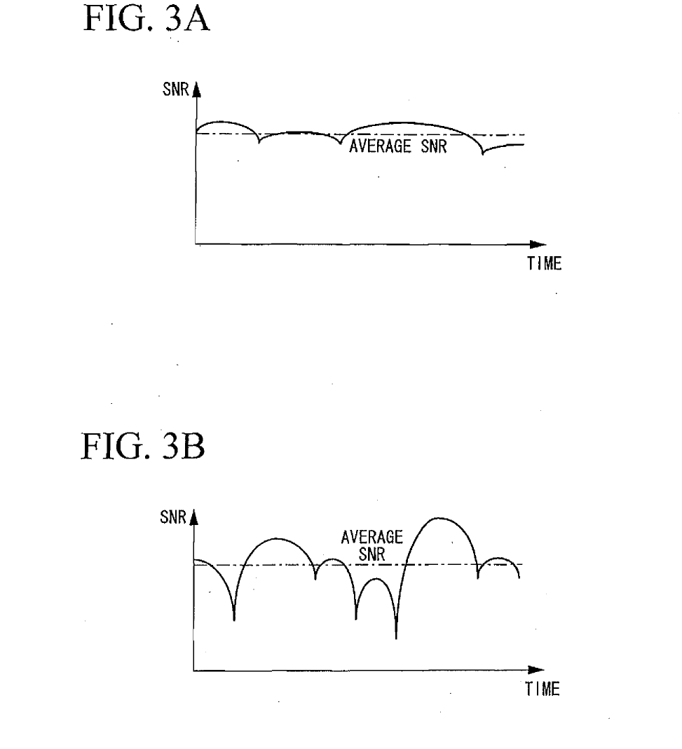

Next, a process for determining the modulation method to be used by the wireless communication system which has the above-described constitution is explained. FIG. 2 is a flowchart showing a process for determining the modulation method to be used by a modulation method determination portion 11 of the base station 1. First, the modulation method determination portion 11 obtains the communication line quality information and the receiving method information from the receiving baseband operation portion 15 that are transmitted from the wireless communication terminal 2 (Step S1). The communication line quality information includes both the average SNR and the SNR fluctuation data which indicates the fluctuation of the SNR. As shown in FIGS. 3A and 3B, the SNR fluctuates and changes in accordance with a moving speed of the wireless communication terminal 2. FIG. 3A shows fluctuation of the SNR with regard to time when the moving speed is slow. As shown in FIG. 3A, the SNR has a small amount of fluctuation with regard to the average SNR when the moving speed is slow. On the other hand, FIG. 3B shows fluctuation of the SNR with regard to time when the moving speed is fast. As shown in FIG. 3B, the SNR has a large amount of fluctuation with regard to the average SNR when the moving speed is fast.

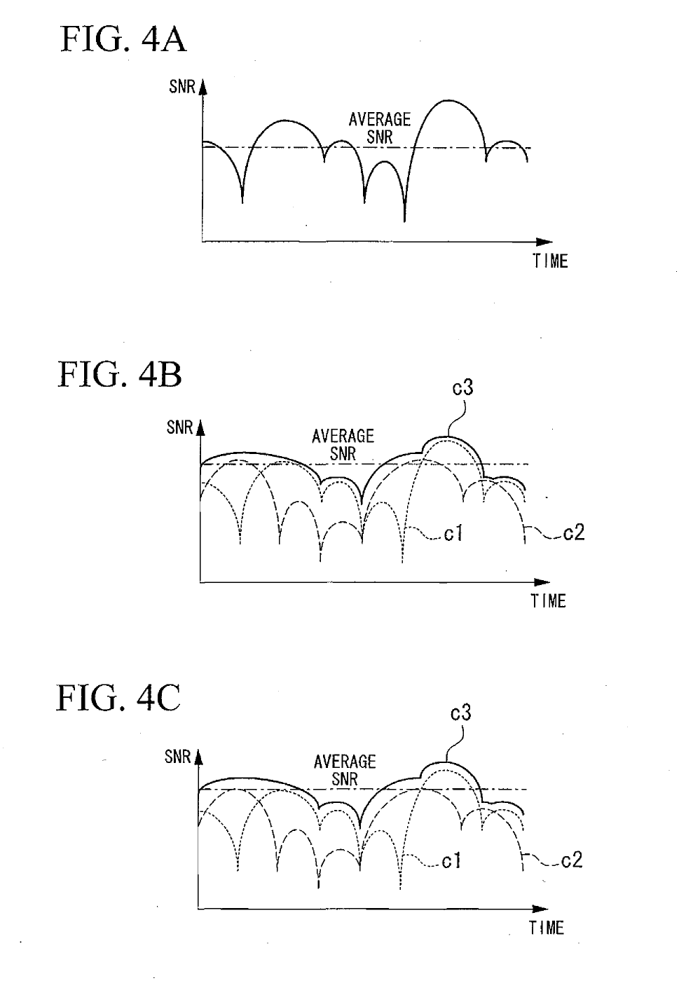

On one hand, as shown in FIGS. 4A-4C, the SNR fluctuates and changes in accordance with receiving methods. FIG. 4A shows fluctuation of the SNR with regard to time when the single antenna receiving method is used. As shown in FIG. 4A, the SNR has a large amount of fluctuation with regard to the average SNR when the single antenna receiving method is used. Moreover, FIG. 4B shows the fluctuation of the SNR with regard to time when the diversity antenna receiving method is used. In FIG. 4B, an example of fluctuation of the SNR is shown in that a pair of antennas A and B (not shown in drawings) is used for receiving. Curve c1 shows fluctuation of the SNR received by the antenna A. Curve c2 shows fluctuation of the SNR received by the antenna B. Curve c3 shows fluctuation of the SNR obtained by a maximum ratio combining the received signals of the antennas A and B. As shown in FIG. 4B, when applying the diversity antenna receiving method, compared to the single antenna receiving method, the SNR has a smaller amount of fluctuation with regard to the average SNR due to maximum ratio combining.

FIG. 4C shows fluctuation of the SNR with regard to time when the adaptive array antenna receiving method is used. In FIG. 4C, in the same manner as FIG. 4B, fluctuation of the SNR is shown as an example by using a pair of antennas A and B (not shown). Curve c1 shows fluctuation of the SNR received by the antenna A, a curve c2 shows fluctuation of the SNR received by the antenna B, and curve c3 shows fluctuation of the SNR obtained by a maximum ratio combining of received signals of the antennas A and B. In the case of applying the adaptive array antenna receiving method, there is a difference compared to the diversity antenna receiving method, in that, a main lobe of directivity of the antenna is directed to the wave which is a target, and a null point (a point at which the directivity pattern of the antenna is decreased) is directed to the unnecessary interference wave. Therefore, it is possible to remove the interference wave, improve the ability to avoid influence of the interference wave, and moreover, it is possible to obtain s slightly smaller amount of fluctuation of the SNR with regard to the average SNR compared to the diversity antenna receiving method.

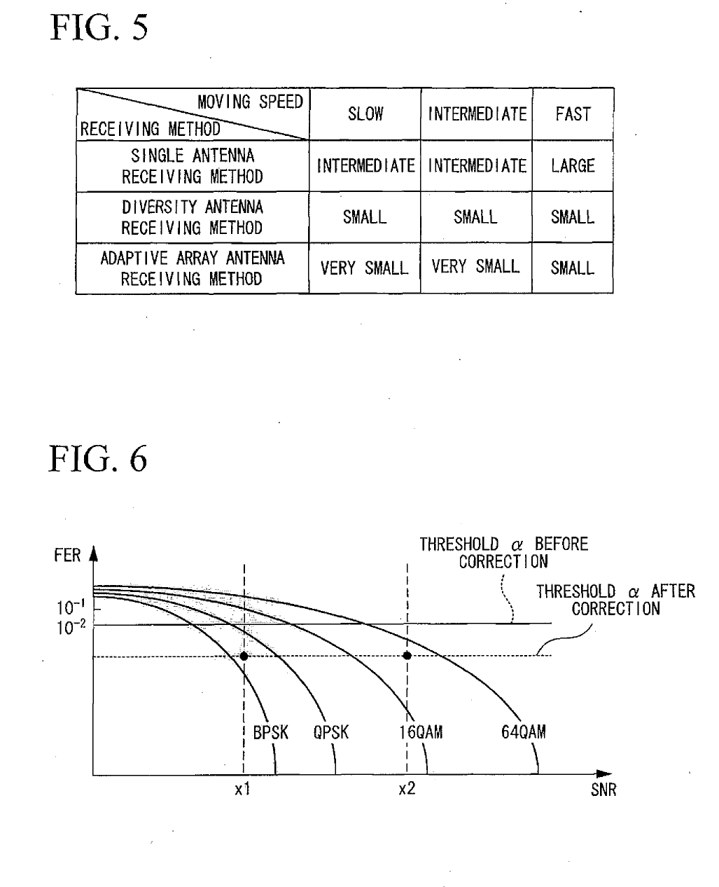

Based on FIGS. 3A, 3B and 4A-4C, a correction value of a threshold α which is a threshold applied for determining the modulation method to be used is determined. FIG. 5 is an example of a correction value table which shows correction values of the threshold α and which shows a guidepost of the correction value. For example, if the moving speed is fast and the receiving method is single antenna receiving method, fluctuation of the SNR indicates the maximum value, and therefore, the correction value of the threshold α is set to the largest value. As shown in FIG. 6, the correction value is set so as to make the threshold α smaller, that is, so as to make the FER smaller). In other words, the correction value is set so as to achieve the strictest or the most severe frame error ratio when the fluctuation of the SNR is the largest. Therefore, it is possible to achieve a better error ratio even if the average SNR fluctuates, and as a result, it is possible to prevent the error rate characteristics from being deteriorated and to improve the throughput. Additionally, as shown in FIG. 6, if the moving speed is slow and the receiving method is the adaptive array antenna receiving method, the fluctuation of the SNR is smallest, and therefore, the correction value of the threshold α is set to the minimum value. This is because there is less possibility of having deteriorated characteristics of the error ratio if the fluctuation of the SNR is small and the average SNR has less fluctuation. The correction value table shown in FIG. 6 is stored beforehand in an inside memory of the adjusting method determination portion 11.

In FIG. 2 again, operations after Step S1 are explained. Based on the receiving method information obtained in Step S1, the modulation method determination portion 11 determines the receiving method by which the wireless communication terminal 2 receives the data (Step S2). After determining the receiving method (Step S3), the modulation method determination portion 11 determines the moving speed (fast, intermediate, slow) of the wireless communication terminal 2 based on the SNR fluctuation data included in the communication line quality information, that is, the fluctuation of the SNR (Step S4). For example, the modulation method determination portion 11 determines fast moving speed if the fluctuation is large. Moreover, after determining the moving speed (Step S5), the modulation method determination portion 11 reads the correction value from the correction value table stored in the inside memory based on both the receiving method determined at Step S3 and the moving speed determined at Step S5 (Step S6); and the modulation method determination portion 11 adds the correction value to the threshold α in order to adjust the threshold α (Step S7).

After that, the modulation method determination portion 11 determines the modulation method in reference to the drawing of characteristics shown in FIG. 6 by comparing both the average SNR and the threshold α which was adjusted in the above-described step (Step S8). For example, when adjusting the threshold α as shown in FIG. 6, if the modulation method determination portion 11 detects that the average SNR is ×1 by comparing the threshold α and characteristics of the SNR which is needed or expected, the modulation method determination portion 11 determines that BPSK should be applied in this embodiment, even though QPSK would have been determined to be applied in accordance with the prior technique. Moreover, if the average SNR is ×2, the modulation method determination portion 11 determines that 16QAM should be applied in this embodiment, even though 64QAM would have been determined to be applied in accordance with the prior technique.

As described above, in accordance with this embodiment, the threshold α is adjusted in consideration of not only the fluctuation of the SNR caused by the moving speed of the wireless communication terminal 2, but also the fluctuation of the SNR caused by applying different receiving methods. Therefore, it is possible to select the most appropriate modulation method, it is possible to prevent characteristics of error ratio from being deteriorated more efficiently than prior techniques, and it is possible to improve the throughput.

It should be noted that the above-described embodiment is not a limitation of the present invention, and it is possible to apply following examples of modifications.

(1) The modulation methods of BPSK, QPSK, 16QAM and 64QAM are shown for explanations in the above-described embodiment. However, this is not a limitation and it is possible apply other modulation methods.

(2) In the above-described embodiment, the SNR is detected as a first parameter to indicate the quality of the communication line. However, this is not a limitation, and it is possible to use something else as the first parameter to indicate the quality of the communication line. On the other hand, the FER is used as a second parameter which indicates the error rate. However, it is possible to use, for example, the BER (Bit Error Rate) as the second parameter.

(3) In the above-described embodiment, the single antenna receiving method, the diversity antenna receiving method, and the adaptive array antenna receiving method are introduced as receiving methods for explanation. However, this is not a limitation, and it is possible to use other receiving methods.

### INDUSTRIAL APPLICABILITY

In accordance with the present invention, the threshold used when determining the modulation method is adjusted or corrected in consideration of fluctuation and changes of the quality of the communication line, and therefore, it is possible to select the most appropriate modulation method, it is possible to prevent the error rate characteristics from being deteriorated and to improve the throughput.

1. A wireless communication system which switches modulation methods applied to communication between a base station and a wireless communication terminal when communicating, wherein
at lest one of the base station and the wireless communication terminal comprises:
a communication line quality detection unit which detects a first parameter with regard to quality of a communication line and detects fluctuation of the first parameter;
a receiving method detection unit which determines a receiving method; and
a modulation method determination unit which determines the modulation method based on the fluctuation of the first parameter and the receiving method.

2. The wireless communication system according to claim 1, wherein
the modulation method detection unit compares an average value of the first parameter and a predetermined threshold which is set to the second parameter and which is adjusted based both on fluctuations of the first parameter and the receiving method in order to determine the modulation method based on pre-calculated characteristics of each of the modulation methods that indicate a relationship between the first parameter and a second parameter of error ratio.

3. The wireless communication system according to claim 1, wherein
the threshold is corrected based on both fluctuation of the first parameter which depends on a moving speed of the wireless communication terminal and fluctuation of the first parameter which depends on the receiving method.

4. The wireless communication system according to claim 1, wherein
the first parameter is a signal-to-noise ratio.

5. The wireless communication system according to claim 1, wherein
the second parameter is a frame error ratio.

6. A wireless communication terminal which communicates with a base station comprising:
a communication line quality detection unit which detects a first parameter with regard to quality of communication line and detects fluctuation of the first parameter;
a receiving method detection unit which detects a receiving method; and
a modulation method determination unit which determines the modulation method based on the fluctuation of the first parameter and the receiving method.

7. A base station which communicates with a wireless communication terminal comprising:
a communication line quality detection unit which detects a first parameter with regard to quality of communication line and detects fluctuation of the first parameter;
a receiving method detection unit which detects a receiving method; and
a modulation method determination unit which determines the modulation method based on the fluctuation of the first parameter and the receiving method.

8. A wireless communication method which switches modulation methods applied to communication between a base station and a wireless communication terminal upon conducting the communication, comprising:
a first step of detecting a first parameter with regard to quality of communication line and detecting fluctuation of the first parameter;
a second step of detecting a receiving method; and
a third step of determining the modulation method based on the fluctuation of the first parameter and the receiving method.

9. A computer program which switches modulation methods applied to communication between a base station and a wireless communication terminal upon conducting the communication, and which is stored in at least one of the base station and the wireless communication terminal, comprising:
a step of detecting a first parameter with regard to quality of communication line and fluctuation of the first parameter and detecting a receiving method; and
a step of determining the modulation method based on the fluctuation of the first parameter and the receiving method.
